(19) United States
(12) Patent Application Publication
(10) Pub. No.: US 2009/0103485 A1
(43) Pub. Date: Apr. 23, 2009

(54) SYSTEM AND METHOD FOR WIRELESS DATA COMMUNICATION HAVING MULTIPLE CHECKSUMS PER FRAME

(75) Inventors: Harkirat Singh, Santa Clara, CA (US); Chiu Ngo, San Francisco, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd., Suwon City (KR)

(21) Appl. No.: 12/133,320

(22) Filed: Jun. 4, 2008

Related U.S. Application Data
(60) Provisional application No. 60/980,759, filed on Oct. 17, 2007.

(51) Int. Cl. H04Q 7/00

(52) U.S. Cl. 370/329

(57) ABSTRACT

A system and method for wireless communication of video data are disclosed. One embodiment of the method includes providing a header and a payload. The payload contains audiovisual data. The method also includes generating a first checksum for the header; generating a second checksum for substantially the entire portions of the header, the payload, and the first checksum; and transmitting over a wireless channel a data packet having a MAC frame including the header, the payload, the first checksum, and the second checksum. This method allows error concealment if errors are only in the payload while raising no fairness issue in old devices.

### RELATED APPLICATION

This application claims priority from U.S. Provisional Patent Application No. 60/980,759, filed on Oct. 17, 2007, which is incorporated herein by reference.

### BACKGROUND OF THE INVENTION

1. Field of the Invention

The present invention relates to wireless data transmission, and particularly to transmission of audiovisual data over wireless channels.

2. Description of the Related Technology

A certain wireless communication system can include a plurality of stations. Each of the stations in the system may be in compliance with a wireless communication standard. When transmitting data between two of the stations in the system, one station may send the other station a data packet having a frame format specified by the communication standard. Other stations in the system may also receive and process the data packet according to the protocols of the communication standard although they may end up discarding the data packet.

Some wireless communication standards keep being updated to include new features. Such updates may require a significant change in the frame format of data packets used in data transmission under a wireless communication standard. In certain instances, stations or devices in compliance only with an old version of the standard may not correctly process a data packet having a new frame format under an updated version of the standard.

A wireless system may include stations manufactured under the updated version of the standard (hereinafter, generally referred to as “new stations”) as well as stations manufactured under the old version of the standard (hereinafter, generally referred to as “old stations”). When a new station sends a data packet having the new frame format to another new station in the system, at least some of old stations in the system may also receive the data packet wirelessly although the old stations are not a destination of the data packet.

Under certain wireless standard protocols, if a receiving station finds that a transmission error has occurred during wireless transmission, it invokes a procedure for remedying the transmission error. Such a procedure may also be invoked in a situation where an old station cannot process a data packet having a new frame format, which is unnecessary when the old station is not a destination of the data packet. Such a problem may be referred to as a “fairness issue” in the context of this document. Thus, there is a need for data packet frame format and/or protocol that do not invoke unnecessary procedures where there are both old and new stations in a wireless communication system.

### SUMMARY OF CERTAIN INVENTIVE ASPECTS

In one embodiment, there is a method of transmitting data over a wireless channel. The method comprises generating a first checksum for a header configured to be part of a data packet for wireless transmission; generating a second checksum for substantially the entirety of the header, the first checksum, and a payload containing data; and transmitting a data packet having a medium access control (MAC) frame over a wireless channel. The MAC frame comprises the header, the payload, the first checksum, and the second checksum.

In another embodiment, there is a method of processing data transmitted over a wireless channel. The method comprises receiving a data packet having a MAC frame over a wireless channel. The MAC frame comprises a header, a payload, a first checksum, and a second checksum. The payload contains data. The first checksum is indicative of whether the header has a transmission error, and the second checksum is indicative of whether substantially the entirety of the header, the payload, and the first checksum has a transmission error. The method also comprises determining whether the second checksum is valid.

In yet another embodiment, there is a wireless communication device for transmitting data. The device comprises a transmitter comprising a media access control (MAC) layer configured to generate a MAC frame for wireless transmission. The MAC frame comprises a header, a payload, a first checksum, and a second checksum. The payload contains data. The transmitter is configured to generate the first checksum for the header. The transmitter is further configured to generate the second checksum for substantially the entirety of the header, the first checksum, and a payload containing data.

In yet another embodiment, there is a wireless communication device for receiving data. The device comprises a receiver configured to receive a data packet having a MAC frame over a wireless channel. The MAC frame comprises a header, a payload, a first checksum, and a second checksum. The payload contains data. The first checksum is indicative of whether the header has a transmission error, and the second checksum is indicative of whether substantially the entirety of the header, the payload, and the first checksum has a transmission error. The receiver is further configured to determine whether any of the first and second checksums is invalid.

In yet another embodiment, there is a system for wireless data transmission. The system comprises a transmitter configured to send a data packet over one or more wireless channels. The data packet comprises a MAC frame including a header, a payload, a first checksum, and a second checksum. The payload contains data. The first checksum is configured to allow a receiver to determine whether the MAC header includes a transmission error, and the second checksum is configured to allow a receiver to determine whether substantially the entirety of the header, the payload, and the first checksum has a transmission error. The system further comprises a first receiver configured to receive the data packet and to determine whether any of the first and second checksums is invalid; and a second receiver configured to receive the data packet and to determine whether the second checksum is invalid, but not whether or not the first checksum is valid.

### BRIEF DESCRIPTION OF THE DRAWINGS

FIG. 1A is a block diagram of a conventional wireless communication system including stations in compliance with IEEE Standard 802.11.

FIG. 1B is a conventional MAC frame format for wireless data transmission in compliance with a version of IEEE Standard 802.11.

FIG. 2A is a block diagram of a wireless communication system including stations according to one embodiment.

FIG. 2B illustrates a fairness issue in a wireless data transmission scheme when used with the wireless communication system of FIG. 2A.

FIG. 3A is a MAC frame format for wireless data transmission according to one embodiment.

FIG. 3B is a MAC frame format for wireless data transmission according to another embodiment.

FIG. 4 is a flowchart illustrating one embodiment of a method of producing the MAC frame of FIG. 3A or 3B at a wireless transmitter.

FIG. 5 is a flowchart illustrating one embodiment of a method of processing the MAC frame of FIG. 3 at a wireless receiver.

FIG. 6 is a flowchart illustrating another embodiment of a method of processing the MAC frame of FIG. 3 at a wireless receiver.

### DETAILED DESCRIPTION OF CERTAIN EMBODIMENTS

The following detailed description of certain embodiments presents various descriptions of specific embodiments of the invention. However, the invention can be embodied in a multitude of different ways as defined and covered by the claims. In this description, reference is made to the drawings where like reference numerals indicate identical or functionally similar elements.

The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

### Wireless System Under IEEE 802.11 Standard

IEEE 802.11 standard is one of wireless standards that are being updated frequently. Because some new versions of IEEE 802.11 standard provide a data packet format different from a data packet format under old versions of the standard, wireless systems including both old and new stations may have a fairness issue. Although the embodiments below are described in the context of IEEE 802.11 standard, a skilled technologist will appreciate that the embodiments can be adapted for any other standards having a similar fairness issue.

IEEE 802.11 provides a specification for wireless local area network (LAN) Medium Access Control (MAC) and Physical Layer (PHY). The IEEE standard defines one medium access control and several physical layer specifications for wireless connectivity for fixed, portable, and moving stations within a local area. The purpose of the IEEE standard is to provide wireless connectivity to automatic machinery, equipment, or stations that require rapid deployment, which may be portable or hand-held, or which may be mounted on moving vehicles within a local area. The standard also offers regulatory bodies a means of standardizing access to one or more frequency bands for the purpose of local area communication.

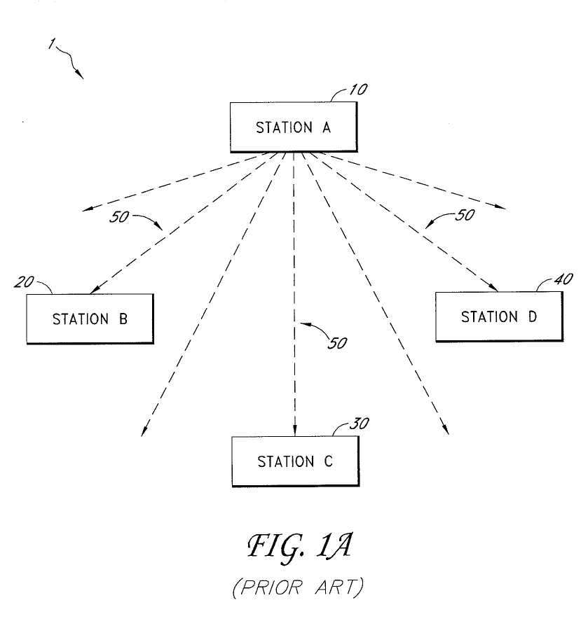

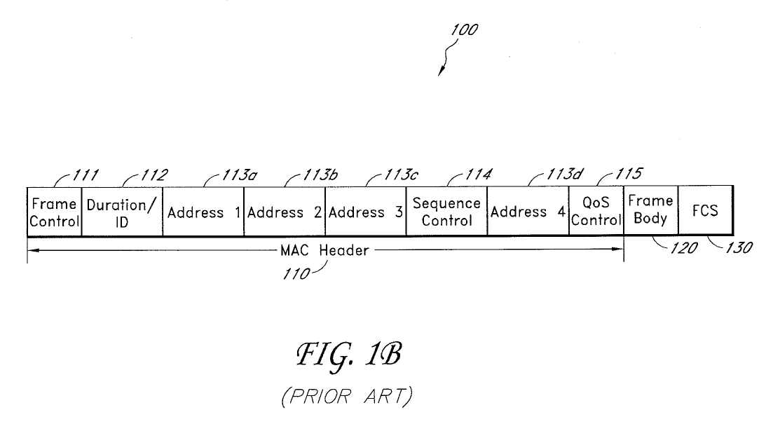

Referring to FIG. 1A, a conventional wireless communication system in compliance with a version of IEEE 802.11 standard is described below. The illustrated system 1 includes a plurality of stations, including first to fourth stations 10-40 and wireless channels 50. Each of the stations 10-40 in the system 1 is in compliance with the same version of IEEE 802.11 standard. When communicating data between two of the stations 10-40, a source station sends a destination station a data packet having a frame format specified by the standard. The destination station and the other stations, within the communication range of the source station, receive the data packet and process it according to the protocols of the standard. The other stations will eventually discard the data packet because the data packet is not destined for the other stations.

Referring to FIG. 1B, the format of a MAC frame in compliance with certain versions of IEEE 802.11 standard (e.g., IEEE Std 802.11a, 802.11b, 802.11d, 802.11g, 802.11h, 802.11i, 802.11j, and 802.11e) will be described below. The disclosures of all versions of IEEE 802.11 standard are incorporated by reference herein in their entireties. The illustrated MAC frame 100 includes, in sequence, a MAC header 110, a frame body field 120, and a frame check sequence (FCS) field 130.

The MAC header 110 may include, in sequence, a frame control field 111, a duration/ID field 112, a first address field 113a, a second address field 113b, a third address field 113c, a sequence control field 114, a fourth address field 113d, and a quality-of-service (QoS) field 115. The frame control field 111 may include information on, for example, protocol version, the function of the frame, data transfer direction in distribution system, additional fragments, retransmission, power management, additional data, encryption of data, and the order of the frame. The duration/ID field 112 may include information on the identifier of the frame transmitting station or a duration value, depending on the frame type. The address fields 113a-113d may include information on the basic service set identification (BSSID), source address (SA), destination address (DA), transmitting station address (TA), and/or receiving station address (RA). The sequence control field 114 may include the sequence number of an MAC service data unit (MSDU) or MAC management protocol data unit (MMPDU), and the number of each fragment of the MSDU or MMPDU. The QoS field may include information on the traffic category (TC) or traffic stream (TS) to which the frame belongs and various other QoS-related information about the frame that varies by frame type.

The frame body field 120 includes data to be carried by the MAC frame. The frame body field 120 can have a variable size. The maximum frame body size can be determined by the maximum MSDU size (MSDU+ICV+IV, where ICV represents integrity check value (ICV), and IV represents initialization vector) plus any overhead from security encapsulation.

The FCS field 130 includes a cyclic redundancy checksum (CRC). The CRC is 32-bit and is calculated over all the fields of the MAC header 110 and the frame body field 120. The FCS may be calculated using the following standard generator polynomial of degree 32 of Equation 1.

G(x)=x³²+x²⁶+x²³+x²²+x¹⁶+x¹²+x¹¹+x¹⁰+x⁸+x⁷+x⁵+x⁴+x²+x+1 Equation 1

During the operation of the wireless system 1 of FIG. 1A, using the MAC frame of FIG. 1B, a transmitting station sends a data packet having the MAC frame to a receiving station over a wireless channel. When producing the MAC frame, the MAC layer of the transmitting station calculates the CRC and adds it to the FCS field 130. The receiving station re-computes the CRC upon receiving the MAC frame over the wireless channel, and compares it with a value stored in the FCS field 130 of the MAC frame 100.

If the calculation of the FCS of the received MAC frame is successful, the receiving station generates a positive acknowledgement, and sends it to the transmitting station. In this instance, the receiving station starts channel contention after waiting for a short interframe space (SIFS) duration. However, if the calculation of the FCS is unsuccessful, the receiving station invokes extended interframe space (EIFS) before starting channel contention. The EIFS has a longer duration than the SIFS, and thus delays channel contention, thereby resulting in a delay in data transmission in the wireless system 1.

A certain system can include both stations in compliance with an earlier version of IEEE 802.11 standard (“old stations”) and stations in compliance with an updated version of the standard (“new stations”). In such a system, a data packet having a frame format according to the updated version can be received by an old station. This may cause a fairness issue. For example, a data packet under IEEE 802.11n standard has a MAC header format different from the MAC header format of FIG. 1B, and thus the FCS of the data packet is also different from the FCS of FIG. 1B. In such a situation, the old station incorrectly calculates the FCS of the data packet, and thus invokes EIFS. To solve this fairness issue, under IEEE 802.11n standard, a contention-free (CF) end frame is transmitted to the old station after SIFS duration to terminate the EIFS.

### MAC Frame Format for Error Concealment

Certain wireless data transmissions can use a data packet that includes a header, a payload, and a frame check sequence (FCS), as the IEEE 802.11 frame of FIG. 1B. The header can include information on the sender and the receiver, and other transmission-related information. In certain arrangements, the payload can include audiovisual data that does not require completely error-free transmission.

In such cases, if there are some bit errors in the data packet, whether they are in the header or the payload, the receiving station will have a failure in calculating the FCS of the data packet. If the bit errors are in the header, the entire packet should be discarded because the receiving station would not be able to determine that the packet is destined for the station. However, if the bit errors are in the payload, the receiving station can still use the data packet by concealing the errors in the audiovisual data in the payload. However, the frame format of the data packet would not allow this selective use of the data packet in error because the calculation of the FCS does not indicate whether the bit errors are in the header or the payload.

In one arrangement, a data packet may have a MAC frame that includes a header, a header checks sequence (HCS), a payload, and a payload check sequence (PCS). When the data packet is formed at a transmitter, the HCS is calculated only over the header, and the PCS is calculated only over the payload. Upon receiving the data packet, a receiver calculates the HCS and the PCS, separately, and can determine whether any of the header and the payload is in error. This frame format allows a selective use of a data packet in error.

If a data packet having such a frame format is used in a wireless system in which all of stations in the system are configured to process such a data packet, there would be no fairness issue. In certain wireless systems, however, some stations in the system may be configured to process such a data packet while other stations are not configured to process such a data packet.

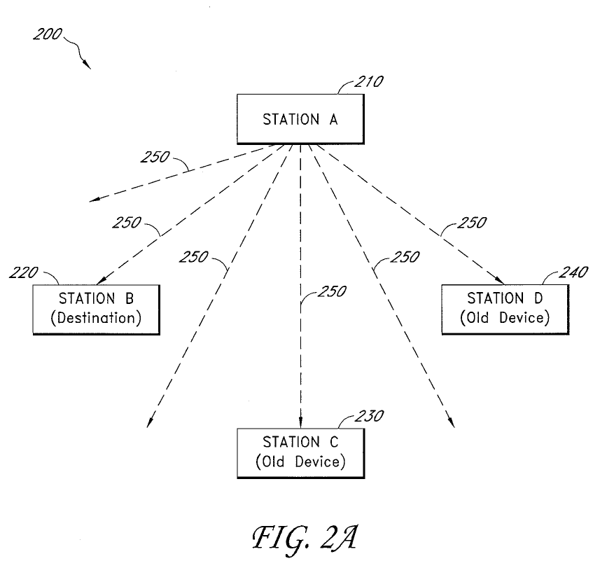

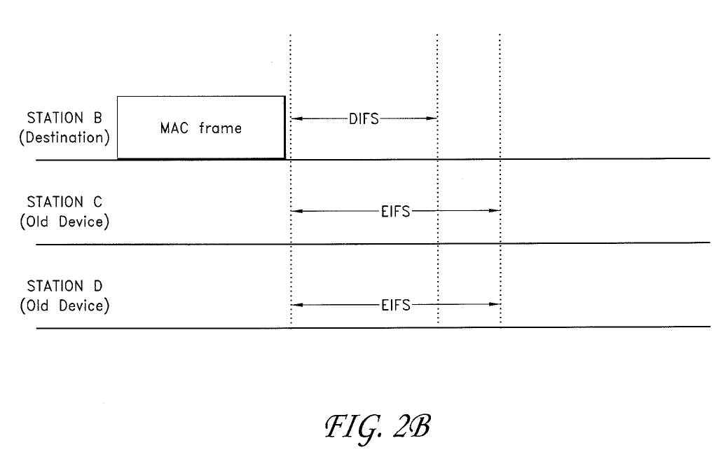

Referring to FIG. 2A, for example, a wireless system 200 includes first to fourth stations 210-240 and wireless channels 250. The first and second stations 210, 220 are configured to process a MAC frame format including header and payload check sequences (HCS and PCS) for the header and the payload, respectively. The third and fourth stations 230, 240 are not configured to process such data packets, but are only configured to process data packets having frame check sequence (FCS) only. Such stations can be referred to as “old stations or devices” in the context of this document.

The wireless system 200 may have a procedure of invoking EIFS when a FCS calculation fails, as in IEEE 802.11 standard. In this instance, when the first station 210 sends a data packet including both HCS and PCS, the second station 220 (which is a destination of the data packet) can process it correctly according to the scheme in which the last field includes a checksum calculated over the payload only. The second station 220 then waits for SIFS or DIFS (distributed coordination function (DCF) interframe space) before starting the next channel access, as shown in FIG. 2B. The durations of SIFS, DIFS, and EIFS may be the same as those specified in IEEE 802.11, the disclosure of which is incorporated by reference.

The third and fourth stations 230, 240, however, process the data packet as if the last field of the data packet included an FCS that has been computed over the entire data packet (i.e., the header and the payload), and would end up miscalculating the checksum. Thus, the third and fourth stations 230, 240 invoke EIFS upon receiving the data packet including both HCS and PCS. EIFS causes the third and fourth stations 230, 240 to wait for EIFS that is longer than SIFS or DIFS before accessing the channel. This is a fairness issue due to a difference in the frame format. Therefore, there is a need for a frame format that does not raise a fairness issue while allowing an error concealment scheme.

In one embodiment, a MAC frame includes a header, a payload, and two separate checksum fields. One of the checksum fields may include a first checksum that can be used to determine whether the header of the MAC frame is in error. The other checksum field may include a second checksum that can be used to determine whether the entire MAC frame is in error. The first checksum may be calculated over the header of the MAC frame at the transmitter. The second checksum may be calculated over substantially the entire portion of the MAC frame except for the second checksum. In the embodiments described below, a device that can process such a MAC frame can be referred to as a new device, and a device that can only process a MAC frame having an FCS at the end of the frame can be referred to as an old device.

The MAC frame described above can be used in a system including both new devices and old devices without raising a fairness issue. The new devices can process the first checksum and the second checksum and determine whether any of the header and the payload of the MAC frame has been corrupted during transmission, as will be better understood below.

The MAC frame is also compatible with the old devices. The old devices may be in compliance with, for example, IEEE standards, including, but not limited to, IEEE 802. 11a, 11b, 11g, 11n, and 11z. The old devices can recognize the second checksum calculated from the entire portion of the MAC frame which is positioned at the end of the MAC frame. Thus, the old devices can use the second checksum of the MAC frame described above in determining whether the MAC frame has been corrupted during transmission, while not invoking EIFS. Because the old devices are not a destination of the data packet, they will end up discarding the data packet.

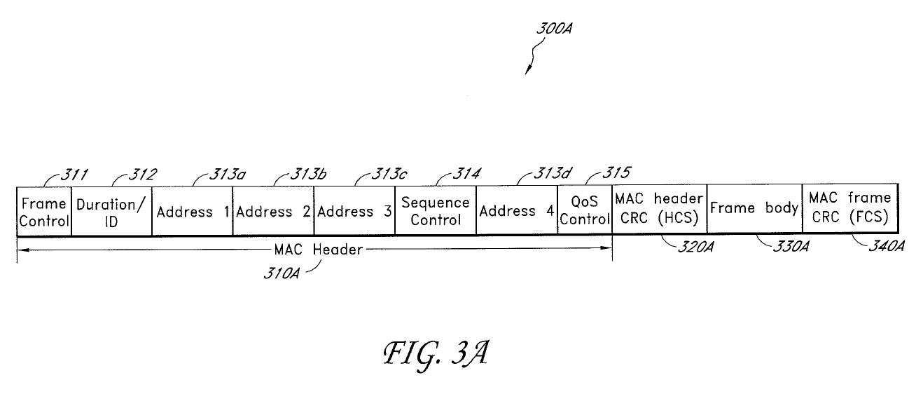

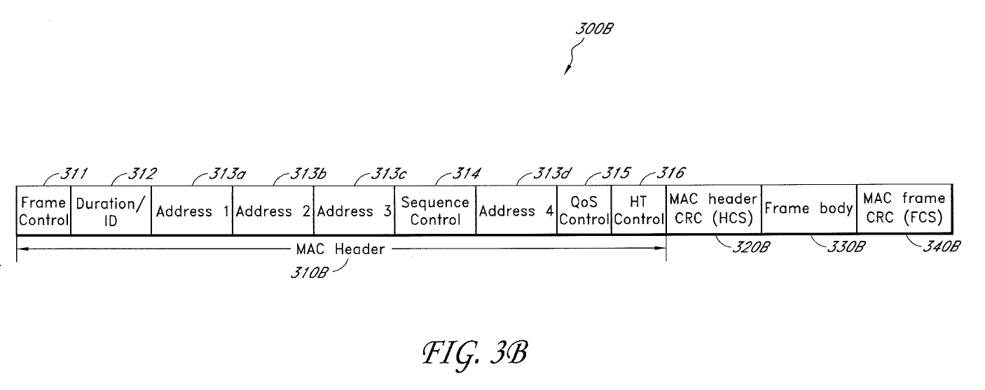

Referring to FIG. 3A, a MAC frame format according to one embodiment will be now described below. The MAC frame 300A can be used with a wireless system, such as the system 200 of FIG. 2A. A data packet having the MAC frame can be transmitted from a transmitter to a receiver over a wireless channel in the system. The illustrated MAC frame format 300A includes a MAC header 310A, a first CRC field 320A, a frame body field 330A, and a second CRC field 340A. The positions of the first CRC field 320A and the frame body field 330A may be exchanged with each other.

The MAC header 310A includes a plurality of subfields that contain information indicative of at least one of a source and a destination for data transmission. The illustrated MAC header 310 includes a frame control field 311, a duration/ID field 312, first to fourth address fields 313a-313d, a sequence control field 314, and a quality of service (QoS) control field 315. The details of the frame control field 311, the duration/ID field 312, the first to fourth address fields, the sequence control field 314, and the QoS control field 315 can be as described above with respect to the MAC header 110 of FIG. 1B.

The first CRC field 320A includes a first cyclic redundancy checksum (CRC) calculated over the MAC header 310A. In one embodiment, the first CRC can be 32 bits long. In other embodiments, the CRC can have a different length. The first CRC can be alternatively referred to as a header check sequence (HCS) in the context of this document.

The frame body field 330A includes data that is carried by the MAC frame. The data can include, but is not limited to, video data, audio data, and text data. In one embodiment, the data can include information, a portion of which can be interpolated or concealed, if corrupted during transmission over the wireless channel, by other uncorrupted portions. In such an embodiment, the data can be video data and/or audio data. In the context of this document, the frame body field 330A may also be referred to as a payload field. Other details of the frame body field 330A can be as described above with respect to the frame body field 120 of FIG. 1B.

The second CRC field 340A includes a second cyclic redundancy checksum (CRC) calculated over the MAC header 310A, the first CRC field 320A, and the frame body field 330A. The second CRC can be a 32-bit CRC. The second CRC can be alternatively referred to as a frame check sequence (FCS) in the context of this document. In one embodiment, the second CRC is configured to be recognized by any old devices complying with any version of IEEE 802.11 standard as if the second CRC were the frame check sequence (FCS) of a MAC frame complying with the version of the standard.

For the purpose of the CRC calculation, the first CRC field 320A is treated as a part of the frame body field 330A. The PHY header of the MAC frame 300A may have a length field which indicates the length of the MAC frame (which may be referred to as MAC Protocol Data Unit or MPDU) including both the MAC header 310A and the frame body field 320A. The length field may include the length of the first CRC field 320A.

Referring to FIG. 3B, a MAC frame format according to another embodiment will be now described below. The MAC frame can be used to carry data that is transmitted from a transmitter to a receiver over a wireless channel. The illustrated MAC frame format 300B may be used to support features of a version of IEEE 802.11 standard, for example, IEEE P802.11n, that supports a system having a high throughput of 100 Mb/s or greater. The illustrated MAC frame 300B includes, in sequence, a MAC header 310B, a first CRC field 320B, a frame body field 330B, and a second CRC field 340B. The positions of the first CRC field 320B and the frame body field 330B may be exchanged with each other.

The MAC header 310B may include, in sequence, a frame control field 311, a duration/ID field 312, a first address field 313a, a second address field 313b, a third address field 313c, a sequence control field 314, a fourth address field 313d, a quality-of-service (QoS) field 315, and a high throughput (HT) field 316. The details of the frame control field 311, the duration/ID field 312, the first to fourth address fields 313a-313d, the sequence control field 314, and the quality-of-service (QoS) field 315 can be as described above with respect to those of FIG. 3A. The HT field 316 may include information on, for example, link adaptation control, calibration position, calibration sequence, channel state information (CSI)/steering, null data packet (NDP) announcement, access category (AC) constraint, and reverse direction grant (RDG)/more physical layer convergence procedure protocol data unit (PPDU).

The first CRC field 320B includes a first cyclic redundancy checksum (CRC) calculated over the MAC header 310B. In one embodiment, the first CRC can be 32 bits long. In other embodiments, the first CRC can have a different length. The first CRC can be alternatively referred to as a header check sequence (HCS) in the context of this document.

The frame body field 330B includes data to be carried by the MAC frame. The frame body field 330B may have a variable size, and may include information specific to individual frame types and subtypes. The minimum frame body may be 0 octet. The maximum length frame body size may be defined by the maximum length MAC service data unit (MSDU) or aggregate MSDU (A-MSDU) plus any overhead for encryption.

The second CRC field 340B includes a second cyclic redundancy checksum (CRC) calculated over the MAC header 310B, the first CRC field 320B, and the frame body field 330B. The second CRC can be a 32-bit CRC. The second CRC can be alternatively referred to as a frame check sequence (FCS) in the context of this document. In one embodiment, the second CRC is configured to be recognized by any old device complying with any version of IEEE 802.11 standard as if the second CRC were the frame check sequence (FCS) of a MAC frame complying with the version of the standard.

The format of FIG. 3B differs from that of FIG. 3A in that it includes the HT control field 316 and has a different length of the frame body field 330C. In addition, at least one of the sequence control field 314, the quality-of-service (QoS) field 315, and the high throughput (HT) field 316 may be omitted from the MAC header 310B.

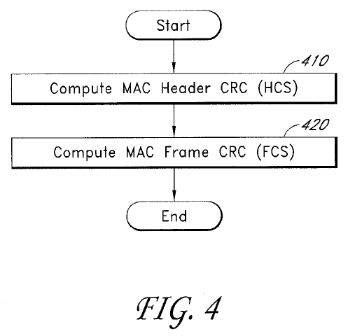

Referring to FIG. 4, a method of producing the MAC frame of FIG. 3A or 3B at a transmitter according to one embodiment will be described below. A MAC header and a frame body are provided to form a MAC frame. The MAC header may include the same fields as described above with respect to FIG. 3A or 3B. The frame body includes data.

First, at block 410, a header checksum sequence (HCS) is calculated over the MAC header. A skilled technologist will appreciate that any suitable process can be used for calculating the HCS. The HCS is then inserted between the MAC header and the frame body to form a MAC frame having the MAC header, the HCS, and the frame body in order.

Subsequently, at block 420, a frame checksum sequence (FCS) is calculated over the MAC frame that has been generated at block 410. The FCS is thus calculated over the entirety of the MAC header, the HCS, and the frame body. The FCS is then attached to the end of the MAC frame. Then, the MAC frame is further processed for wireless transmission, and is transmitted in the form of a data packet to stations in the wireless system.

When receiving the data packet, old stations, if any, in the wireless system are unaware of the existence of both the HCS and FCS. The old stations simply calculate the FCS which has been computed over the entire MAC frame at the transmitter, and compare the result against a value stored in the FCS. Since the two values are calculated in a similar fashion, there would not be any checksum failure if the data packet has been received by the old stations without transmission error. After successfully calculating the checksum, the old stations would eventually drop the data packet since the data packet is not destined for the old stations. The destination of the packet can be determined by checking the receiver address in the MAC header, which would not match the addresses of the old stations. The old stations, however, do not invoke EIFS since checksum computation has not failed.

On the other hand, the destination stations are aware of the two CRC fields. This can be achieved by exchanging control messages at the stream-set up stage, by exchanging capability, or by including special bits in the MAC header of the MAC frame. In addition, the destination stations know how to compute the two CRCs and the position of the additional CRC (HCS) in the MAC frame.

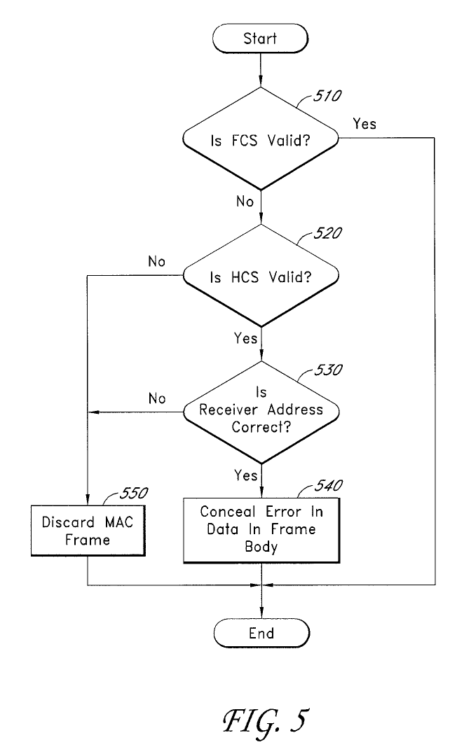

Referring to FIG. 5, one embodiment of a method of processing the MAC frame of FIG. 3A or 3B at a receiver will be described below. The receiver receives data packets having the MAC frame over a wireless channel. The receiver processes the data packets to extract the MAC frame. Then, the receiver processes the MAC frame at the MAC layer of the receiver as set forth below.

First, it is determined whether the frame check sequence (FCS) is valid at block 510. If yes, the process is terminated because such a FCS indicates that the entire MAC frame has no transmission error. The frame body is extracted from the MAC frame, and is transferred to another component of the receiver to extract the data in the frame body. If no, the process goes to block 520.

At block 520, it is determined whether the header check sequence (HCS) is valid. If yes, the process goes to block 530. A HCS determined to be valid at block 520 indicates that the MAC header is valid, but the frame body has been corrupted during the wireless transmission. If no, the MAC frame is discarded at block 550. In this instance, the receiver may invoke EIFS.

At block 530, it is determined whether the receiver address is correct. If yes, the data in the frame body is further processed as valid data at block 540. In one embodiment, errors in the data are concealed by various error correction schemes, such as interpolating, or copying portions of uncorrupted data. In other embodiments, the data can be used without concealing the errors. The data is then transferred to another component of the receiver for further processing.

Since the receiver now accepts the MAC frame, the receiver may modify EIFS behavior such that EIFS is not triggered even though the FCS has failed. The receiver may also generate an acknowledgment signal for the MAC frame when the EIFS is not triggered. At block 530, if the answer is no, the MAC frame is discarded at block 550. The receiver may simply discard the data packet without invoking EIFS because the data packet is not destined for the receiver.

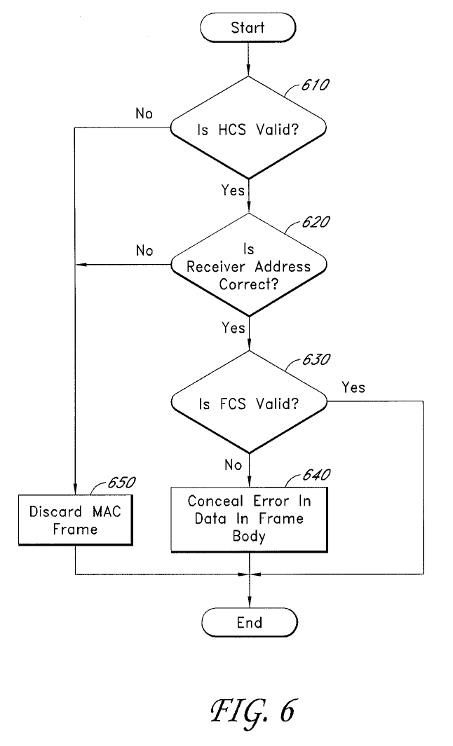

Referring to FIG. 6, another embodiment of a method of processing the MAC frame of FIG. 3A or 3B at a receiver will be now described below. The receiver receives data packets including the MAC frame over a wireless channel. The receiver processes the data packets to extract the MAC frame. Then, the receiver processes the MAC frame at the MAC layer of the receiver as set forth below.

First, it is determined whether the header checksum (HCS) is valid at block 610. If yes, the process goes to block 620. If no, the MAC frame is discarded at block 650. In this instance, the receiver may invoke EIFS.

At block 620, it is determined whether the receiver address is correct. If yes, it is determined whether the frame checksum (FCS) is valid at block 630. If no, the MAC frame is discarded at block 650. In this instance, the receiver may not invoke EIFS because the packet is not destined for the receiver.

At block 630, it is determined whether the frame check sequence (FCS) is valid. If yes, the process is terminated because a FCS determined to be valid at block 630 indicates that the entire MAC frame has no error. The frame body is transferred to another component of the receiver to extract the data from the frame body. If no, the process goes to block 640. A FCS determined to be invalid at block 630 indicates that the MAC header is valid, but the frame body has been corrupted during the wireless transmission.

The data in the frame body is further processed as valid data at block 640. In one embodiment, errors in the data are concealed by various error correction schemes, such as interpolating, or copying portions of uncorrupted data. In other embodiments, the data can be used without concealing the errors. The data is then transferred to another component of the receiver for further processing. Since the receiver now accepts the MAC frame, the receiver may modify EIFS behavior such that EIFS is not triggered even though the FCS has failed. The receiver may also generate an acknowledgment signal for the MAC frame when the EIFS is not triggered.

The embodiments described above allow a wireless device to selectively use a data packet in error, depending on whether errors are in the MAC header or the payload of the packet. In addition, when used in a system including old devices, the frame format does not incur a fairness issue because the frame format can be processed by the old devices. This scheme in effect enhances the overall performance of a wireless system by reducing unnecessary waiting periods between channel access periods.

The embodiments described above may be used for video streaming over a wireless local area network (WLAN). In one embodiment, the embodiments can be adapted for a wireless system having a very high throughput (VHT) with a bandwidth of less than about 6 GHz. In other embodiments, the embodiments can be adapted for a wireless system having a bandwidth of 60 GHz.

The foregoing description is that of embodiments of the invention and various changes, modifications, combinations and sub-combinations may be made without departing from the spirit and scope of the invention, as defined by the appended claims.

What is claimed is:

1. A method of transmitting data over a wireless channel, the method comprising:
generating a first checksum for a header configured to be part of a data packet for wireless transmission;
generating a second checksum for substantially the entirety of the header, the first checksum, and a payload containing data; and
transmitting a data packet having a medium access control (MAC) frame over a wireless channel, the MAC frame comprising the header, the payload, the first checksum, and the second checksum.

2. The method of claim 1, wherein the first checksum includes a cyclic redundancy checksum configured to allow a receiver to determine whether the MAC header includes a transmission error.

3. The method of claim 1, wherein the second checksum includes a cyclic redundancy checksum configured to allow a receiver to determine whether the entire MAC frame includes a transmission error.

4. The method of claim 1, wherein the MAC frame includes, in sequence, the header, the first checksum, the payload, and the second checksum.

5. The method of claim 4, wherein the second checksum comprises a checksum substantially identical to a frame check sequence (FCS) of a MAC frame in compliance with at least one version of IEEE 802.11 standard.

6. The method of claim 5, wherein the second checksum is configured not to invoke extended interframe space (EIFS) if there is no transmission error.

7. The method of claim 1, wherein the data comprises audio-visual data.

8. A method of processing data transmitted over a wireless channel, the method comprising:
receiving a data packet having a medium access control (MAC) frame over a wireless channel, the MAC frame comprising a header, a payload, a first checksum, and a second checksum, the payload containing data, wherein the first checksum is indicative of whether the header has a transmission error, and wherein the second checksum is indicative of whether substantially the entirety of the header, the payload, and the first checksum has a transmission error; and
determining whether the second checksum is valid.

9. The method of claim 8, further comprising determining whether the first checksum is valid; and discarding the data packet if the first checksum is invalid.

10. The method of claim 9, wherein the header comprises a receiver address, and wherein the method further comprises determining whether the receiver address is valid; and discarding the data packet if the receiver address is invalid.

11. The method of claim 10, wherein the data in the payload comprises audiovisual data.

12. The method of claim 11, further comprising concealing errors in the data in the payload if the first checksum and the receiver address are valid and the second checksum is invalid.

13. The method of claim 12, wherein the method comprises, in sequence:
determining whether the second checksum is valid;
determining whether the first checksum is valid; and
determining whether the receiver address is valid.

14. The method of claim 12, wherein the method comprises, in sequence:
determining whether the first checksum is valid;
determining whether the receiver address valid; and
determining whether the second checksum is valid.

15. The method of claim 8, wherein the second checksum comprises a checksum substantially identical to a frame check sequence (FCS) of a medium access control (MAC) frame in compliance with at least one version of IEEE 802.11 standard.

16. The method of claim 8, wherein the method does not include determining whether the first checksum is valid.

17. The method of claim 8, further comprising invoking a procedure for correcting a transmission error only if the first checksum is invalid.

18. The method of claim 17, wherein invoking the procedure comprises invoking extended interframe space (EIFS).

19. The method of claim 17, further comprising transmitting an acknowledgment signal over the wireless channel if the procedure is not invoked.

20. A wireless communication device for transmitting data, the device comprising:
a transmitter comprising a medium access control (MAC) layer configured to generate a medium access control (MAC) frame for wireless transmission, the MAC frame comprising a header, a payload, a first checksum, and a second checksum, the payload containing data;
wherein the transmitter is configured to generate the first checksum for the header; and
wherein the transmitter is further configured to generate the second checksum for substantially the entirety of the header, the first checksum, and a payload containing data.

21. The device of claim 20, wherein the first checksum includes a cyclic redundancy checksum configured to allow a receiver to determine whether the MAC header includes a transmission error.

22. The device of claim 20, wherein the second checksum includes a cyclic redundancy checksum configured to allow a receiver to determine whether the entire MAC frame includes a transmission error.

23. The device of claim 20, wherein the MAC frame includes, in sequence, the header, the first checksum, the payload, and the second checksum.

24. The device of claim 23, wherein the second checksum comprises a checksum substantially identical to a frame check sequence (FCS) of a medium access control (MAC) frame in compliance with at least one version of IEEE 802.11 standard.

25. A wireless communication device for receiving data, the device comprising:
a receiver configured to receive a data packet having a medium access control (MAC) frame over a wireless channel, the MAC frame comprising a header, a payload, a first checksum, and a second checksum, the payload containing data, wherein the first checksum is indicative of whether the header has a transmission error, and wherein the second checksum is indicative of whether substantially the entirety of the header, the payload, and the first checksum has a transmission error,
wherein the receiver is further configured to determine whether any of the first and second checksums is invalid.

26. The device of claim 25, wherein the receiver is further configured to discard the data packet if the first checksum is invalid.

27. The device of claim 26, wherein the header comprises a receiver address, and wherein the receiver is further configured to determine whether the receiver address is valid, and to discard the data packet if the receiver address is invalid.

28. The device of claim 27, wherein the data in the payload comprises audiovisual data.

29. The device of claim 28, wherein the receiver is further configured to conceal errors in the data in the payload if the first checksum and the receiver address are valid and the second checksum is invalid.

30. The device of claim 25, wherein the second checksum comprises a checksum substantially identical to a frame check sequence (FCS) of a medium access control (MAC) frame in compliance with at least one version of IEEE 802.11 standard.

31. A system for wireless data transmission, the system comprising:
a transmitter configured to send a data packet over one or more wireless channels, the data packet comprising a medium access control (MAC) frame including a header, a payload, a first checksum, and a second checksum, the payload containing data, wherein the first checksum is configured to allow a receiver to determine whether the header includes a transmission error, and wherein the second checksum is configured to allow a receiver to determine whether substantially the entirety of the header, the payload, and the first checksum has a transmission error;
a first receiver configured to receive the data packet and to determine whether any of the first and second checksums is invalid; and
a second receiver configured to receive the data packet and to determine whether the second checksum is invalid, but not whether or not the first checksum is valid.

32. The system of claim 31, wherein the second checksum is configured not to invoke extended interframe space (EIFS) when the second receiver receives the data packet.
